(19) United States
(12) Patent Application Publication
(10) Pub. No.: US 2018/0263047 A1
(43) Pub. Date: Sep. 13, 2018

(54) METHOD AND APPARATUS FOR TRANSMITTING DATA UNIT ON BASIS OF TRIGGER FRAME

(71) Applicant: LG ELECTRONICS INC., Seoul (KR)

(72) Inventors: Suhwook KIM, Seoul (KR); Kiseon RYU, Seoul (KR); Wookbong LEE, Seoul (KR); Hangyu CHO, Seoul (KR)

(73) Assignee: LG ELECTRONICS INC., Seoul (KR)

(21) Appl. No.: 15/534,279

(22) PCT Filed: May 19, 2015
(86) PCT No.: PCT/KR2015/005002

§ 371 Date: Jun. 8, 2017

Related U.S. Application Data
(60) Provisional application No. 62/096,884, filed on Dec. 25, 2014.

(51) Int. Cl. H04W 72/12; H04L 29/06; H04W 74/00; H04L 5/00; H04W 52/02

(52) U.S. Cl. CPC H04W 72/1205; H04L 69/22; H04W 52/0216; H04L 5/0053; H04W 74/002

(57) ABSTRACT

Disclosed are a method and an apparatus for transmitting a data unit on the basis of a trigger frame. A method of transmitting a data unit in a wireless LAN may comprise the steps in which: an STA receives a trigger frame from an AP; and in response to the trigger frame, the STA transmits, to the AP, an UL MU PPDU on a sub-channel, wherein a PPDU header of the UL MU PPDU comprises a MAC indicator field and at least one MAC header field, the MAC indicator field comprises at least one sub-indicator, each of the at least one sub-indicator indicates whether or not each of the at least one MAC header field is present, and each of the at least one MAC header field may correspond to each of the at least one field included in the MAC header of the UL MU PPDU.

### BACKGROUND OF THE INVENTION

### Field of the Invention

The present invention relates to wireless communication and, most particularly, to a method and apparatus for transmitting a data unit on the basis of a trigger frame.

### Related Art

With the spreading of smart devices, such as smart phones, tablets, smart electronic appliances, and so on, wireless communication that is based on a wireless local area network (WLAN) is increasing. In a wireless LAN network, communication may be performed based on a physical layer (PHY) protocol data unit (PPDU).

A PPDU may broadly include a PHY preamble, a PHY header, and a data payload (or medium access control (MAC) payload). The term PPDU header may also be used as a concept of including a PHY preamble and a PHY header.

A PHY preamble may include a short training field (STF) and a long training field (LTF) for synchronization and channel estimation. The STF, which is included in a PLCP preamble, may be used for signal detection, automatic gain control (AGC), diversity selection, time synchronization, and frequency error estimation.

A PHY header may include a rate field, which includes information related to a transmission rate, and a length field, which indicates a length of the PPDU.

A data payload (or data field) may include a PHY service data unit (PSDU), a service, tail bits, and a pad bit. The tail bits may be used to turn a convolution encoder to its initial state, and the pad bit may correspond to a bit that is added in order to configure a total number of data bits to be equal to a multiple of the encoded bits of an orthogonal frequency division multiplexing (OFDM) symbol. All of the bits being included in the data payload may be transmitted after being processed with scrambling, convolution encoding, and interleaving.

### SUMMARY OF THE INVENTION

### Technical Objects

An object of the present invention is to provide a method for transmitting a data unit on the basis of a trigger frame.

Another object of the present invention is to provide an apparatus for transmitting a data unit on the basis of a trigger frame.

### Technical Solutions

In order to achieve the above-described technical object of the present invention, according to an aspect of the present invention, a method for transmitting data units in a wireless LAN system may include the steps of receiving, by a station (STA), a trigger frame from an access point (AP), and transmitting, by the STA, an uplink multi user PHY protocol data unit (UL MU PPDU) to the AP within a sub-channel as a response to the trigger frame, wherein the trigger frame may include UL MU identification information and UL MU resource allocation information, wherein the UL MU identification information may include identification information of the STA and identification information of another STA transmitting another PPDU within a time resource overlapping with the STA, wherein the UL MU resource allocation information may include information on the sub-channel and information on another sub-channel for transmitting the other UL MU PPDU, wherein a PPDU header of the UL MU PPDU may include a medium access control (MAC) indicator field and at least one MAC header indicator, wherein the MAC indicator field may include at least one sub-indicator, wherein each of the at least one sub-indicator may indicate a presence or absence of the at least one MAC header field, and wherein each of the at least one MAC header field may correspond to each of at least one field being included in a MAC header of the UL MU PPDU.

In order to achieve the above-described technical object of the present invention, according to another aspect of the present invention, a station (STA) transmitting data units in a wireless LAN may include a radio frequency (RF) unit transmitting and receiving radio signals, and a processor being operatively connected to the RF unit, wherein the processor may be configured to receive a trigger frame from an access point (AP), and to transmit an uplink multi user PHY protocol data unit (UL MU PPDU) to the AP within a sub-channel as a response to the trigger frame, wherein the trigger frame may include UL MU identification information and UL MU resource allocation information, wherein the UL MU identification information may include identification information of the STA and identification information of another STA transmitting another PPDU within a time resource overlapping with the STA, wherein the UL MU resource allocation information may include information on the sub-channel and information on another sub-channel for transmitting the other UL MU PPDU, wherein a PPDU header of the UL MU PPDU may include a medium access control (MAC) indicator field and at least one MAC header indicator, wherein the MAC indicator field may include at least one sub-indicator, wherein each of the at least one sub-indicator may indicate a presence or absence of the at least one MAC header field, and wherein each of the at least one MAC header field may correspond to each of at least one field being included in a MAC header of the UL MU PPDU.

### Effects of the Invention

Information being included in a MAC header may be included in a PPDU header of a PHY protocol data unit (PPDU). Therefore, overhead of re-transmission caused by an error in a MAC payload may be reduced, and a station (STA) may quickly determine subsequent operations by only performing decoding on the PPDU header without having to perform decoding of the MAC header.

### BRIEF DESCRIPTION OF THE DRAWINGS

FIG. 1 is a conceptual view illustrating the structure of a wireless local area network (WLAN).

FIG. 2 is a conceptual diagram illustrating an A-MSDU.

FIG. 3 is a conceptual diagram illustrating an A-MPDU.

FIG. 4 is a conceptual diagram illustrating DL MU transmission according to an exemplary embodiment of the present invention.

FIG. 5 is a conceptual view illustrating a DL MU PPDU according to an exemplary embodiment of the present invention.

FIG. 6 is a conceptual view illustrating a MAC indicator field included in a PPDU header according to an exemplary embodiment of the present invention.

FIG. 7 is a conceptual view illustrating a DL MU PPDU format according to an exemplary embodiment of the present invention.

FIG. 8 is a conceptual diagram illustrating UL MU transmission according to an exemplary embodiment of the present invention.

FIG. 9 is a conceptual view illustrating a UL MU PPDU according to an exemplary embodiment of the present invention.

FIG. 10 is a conceptual view illustrating a UL MU PPDU being transmitted by a UL MU target STA according to an exemplary embodiment of the present invention.

FIG. 11 is a conceptual view illustrating a UL MU PPDU format according to an exemplary embodiment of the present invention.

FIG. 12 is a block view illustrating a wireless device to which the exemplary embodiment of the present invention can be applied.

### DESCRIPTION OF EXEMPLARY EMBODIMENTS

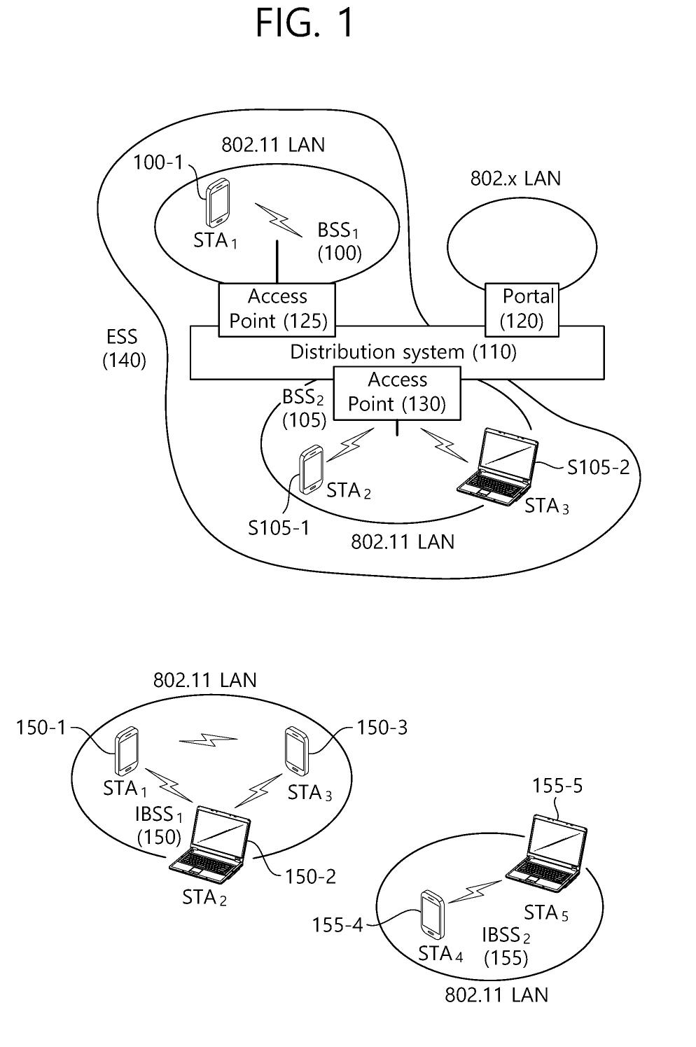

FIG. 1 is a conceptual view illustrating the structure of a wireless local area network (WLAN).

An upper part of FIG. 1 illustrates the structure of an infrastructure basic service set (BSS) of institute of electrical and electronic engineers (IEEE) 802.11.

Referring the upper part of FIG. 1, the wireless LAN system may include one or more infrastructure BSSs 100 and 105 (hereinafter, referred to as BSS). The BSSs 100 and 105 as a set of an AP and an STA such as an access point (AP) 125 and a station (STA1) 100-1 which are successfully synchronized to communicate with each other are not concepts indicating a specific region. The BSS 105 may include one or more STAs 105-1 and 105-2 which may be joined to one AP 130.

The BSS may include at least one STA, APs providing a distribution service, and a distribution system (DS) 110 connecting multiple APs.

The distribution system 110 may implement an extended service set (ESS) 140 extended by connecting the multiple BSSs 100 and 105. The ESS 140 may be used as a term indicating one network configured by connecting one or more APs 125 or 230 through the distribution system 110. The AP included in one ESS 140 may have the same service set identification (SSID).

A portal 120 may serve as a bridge which connects the wireless LAN network (IEEE 802.11) and another network (e.g., 802.X).

In the BSS illustrated in the upper part of FIG. 1, a network between the APs 125 and 130 and a network between the APs 125 and 130 and the STAs 100-1, 105-1, and 105-2 may be implemented. However, the network is configured even between the STAs without the APs 125 and 130 to perform communication. A network in which the communication is performed by configuring the network even between the STAs without the APs 125 and 130 is defined as an Ad-Hoc network or an independent basic service set (IBSS).

A lower part of FIG. 1 illustrates a conceptual view illustrating the IBSS.

Referring to the lower part of FIG. 1, the IBSS is a BSS that operates in an Ad-Hoc mode. Since the IBSS does not include the access point (AP), a centralized management entity that performs a management function at the center does not exist. That is, in the IBSS, STAs 150-1, 150-2, 150-3, 155-4, and 155-5 are managed by a distributed manner. In the IBSS, all STAs 150-1, 150-2, 150-3, 155-4, and 155-5 may be constituted by movable STAs and are not permitted to access the DS to constitute a self-contained network.

The STA as a predetermined functional medium that includes a medium access control (MAC) that follows a regulation of an Institute of Electrical and Electronics Engineers (IEEE) 802.11 standard and a physical layer interface for a radio medium may be used as a meaning including all of the APs and the non-AP stations (STAs).

The STA may be called various a name such as a mobile terminal, a wireless device, a wireless transmit/receive unit (WTRU), user equipment (UE), a mobile station (MS), a mobile subscriber unit, or just a user.

An access point (AP), which operates in a wireless local area network (WLAN) system, may transmit data to each of a plurality of stations (STAs) through the same time resource. If a transmission from the AP to the STA is referred to as a downlink transmission, a transmission performed by such AP to each of a plurality of STAs may be expressed by using the term downlink multi-user transmission (DL MU transmission) (or downlink multiple user transmission).

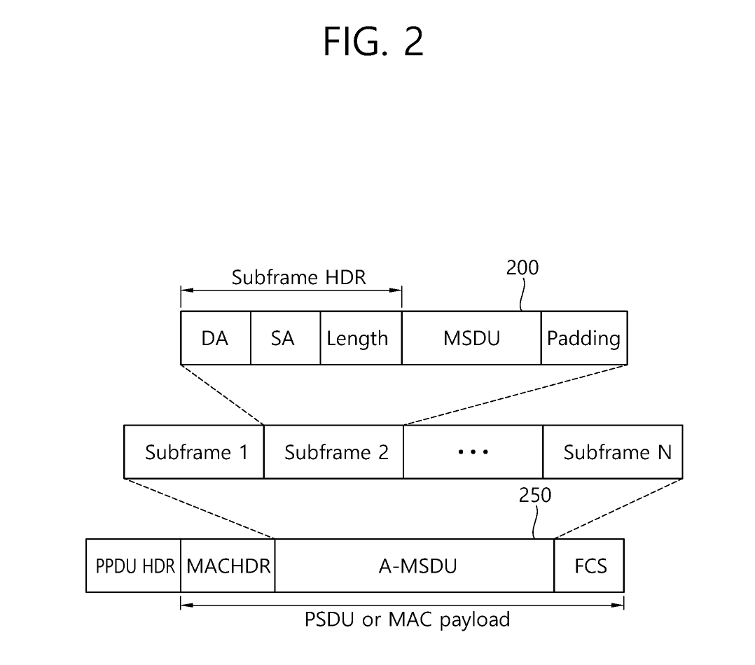

FIG. 2 is a conceptual diagram illustrating an A-MSDU.

In a wireless LAN system, a method for performing aggregation on a data frame in order to reduce medium access control (MAC) error overhead has been defined. A MAC service data unit (MSDU) 200, which is generated in an application layer for the aggregation of the data frame, may be processed with aggregation (i.e., aggregated) in a higher layer of the MAC layer so as to be generated as a single data unit. The MSDU that is aggregated in the higher layer of the MAC layer may be defined by using the term aggregate-MSDU (A-MSDU) 250. The A-MSDU 250 may be generated based on an aggregation of multiple MSDUs 200 each having the same priority level and each having the same receiver address (RA).

A plurality of A-MSDU subframes may be grouped so as to form a single A-MSDU 250. More specifically, the A-MSDU 250 may include a plurality of A-MSDU subframes, and an A-MSDU subframe may include a subframe header, an MSDU, and a padding bit. The subframe header may include a destination address (DA), a source address (SA), and a MSDU length. The padding bit may be used in order to configure a total length of the A-MSDU subframe to have a total length that is equal to a multiple of a predetermined number (e.g., a multiple of 4 octets).

Unlike the single MSDU, instead of being fragmented (or processed with fragmentation), the A-MSDU 250 may be configured as a QoS data MAC protocol data unit (MPDU) and may then be transmitted. For example, the A-MSDU 250 may be transmitted by a high throughput (HT) STA of a management information base (MIB) field. An HT STA has a capability of performing de-aggregation of the A-MSDU 250, and the HT-STA verifies whether or not an a-MSDU 250 exists in a QoS field of a MAC header of the received PPDU, and, then, the HT STA may de-aggregate the A-MSDU 250.

In case the ACK policy of the HT STA is configured as a normal ACK, the A-MSDU 250 may not be aggregated as an A-MPDU. Additionally, whether or not the A-MSDU 250 can be aggregated to the A-MPDU may vary depending upon whether or not a block acknowledgement (ACK) agreement has been established (or made) for each traffic identifier (TID). Additionally, even if a block ACK agreement has been established with respect to a TID, in case an A-MSDU block ACK supportability indicator of an add block acknowledgement (ADDBA) response frame of the receiving end corresponding to the add block acknowledgement (ADDBA) request frame indicates that block ACK is not supported, the A-MSDU 250 may not be included in the A-MPDU.

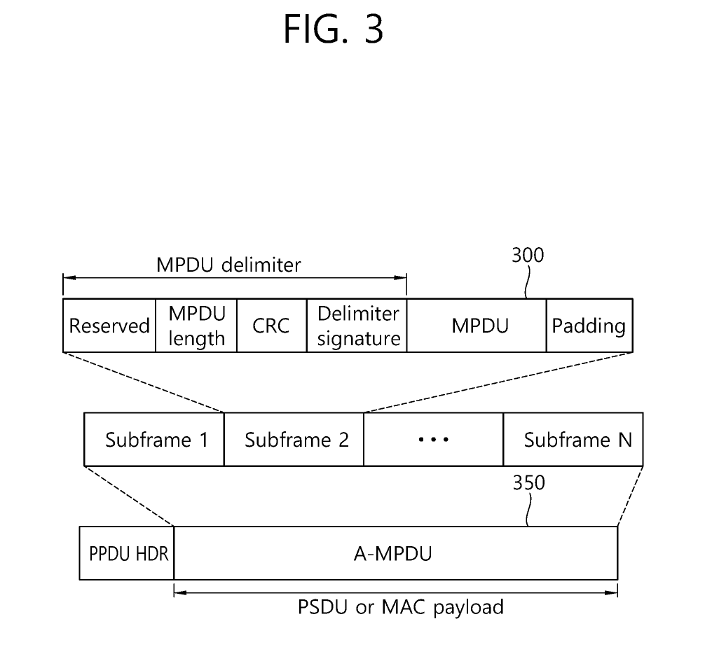

FIG. 3 is a conceptual diagram illustrating an A-MPDU.

Referring to FIG. 3, a single A-MPDU 350 may be configured at a lower portion of the MAC layer by grouping multiple MPDUs 300 each having the same receiver address (RA), TID, and ACK policy.

The A-MPDU 350 is configured of one or more A-MPDU subframes, and each A-MPDU subframe may include an MPDU delimeter and an MPDU 300. An MPDU delimeter may be used in order to determine whether or not an error exists in the A-MPDU subframe(s) configuring the A-MPDU 350. Multiple A-MPDU subframes may configure a single A-MPDU 350.

Whether or not the reception of the A-MPDU 350 is successful may be indicated based on a block ACK. The A-MPDU 350 may be configured only for a TID that has established an HT-immediate BA agreement, and values of duration/ID fields of the MPDU 300 configuring the A-MPDU 350 may be set to be equal to one another.

The A-MPDU (or MPDU) may be included in a physical layer (PHY) service data unit (PSDU). A PSDU and a PPDU header (PHY preamble and PHY header) may configure a PHY protocol data unit (PPDU). The A-MPDU (or MPDU) may also be interpreted as a data unit that is equal to a frame.

An AP operating in the wireless LAN system may transmit data to each of the plurality of STAs through an overlapped time resource. If a transmission from the AP to the STA is referred to as a downlink transmission, such transmission of the AP may also be expressed by using the term downlink multi-user transmission (DL MU transmission) (or downlink multiple user transmission). Conversely, a DL single user (SU) transmission may indicate a downlink transmission from the AP to one STA within the entire transmission resource.

In the legacy wireless LAN system, the AP was capable of performing DL MU transmission based on multiple input multiple output (MU MIMO), and such transmission may be expressed by using the term DL MU MIMO transmission. In the exemplary embodiment of the present invention, the AP may perform DL MU transmission based on an orthogonal frequency division multiplexing access (OFDMA), and such transmission may be expressed by using the term DL MU OFDMA transmission. In case the DL MU OFDMA transmission is performed, the AP may transmit downlink data (or downlink frames, downlink PPDUs) to each of the multiple STAs through each of the multiple frequency resources within an overlapped time resource. The DL MU OFDMA transmission may be used along with the DL MU MIMO transmission. For example, a DL MU MIMO transmission that is based on a plurality of space-time streams (or spatial streams) within a specific subband (or sub channel), which is allocated for the DL MU OFDMA transmission.

Each of the PPDU, frame, and data that are transmitted via downlink transmission may be respectively expressed by using the terms downlink PPDU, downlink frame, and downlink data. The PPDU may correspond to a data unit including a PPDU header and a physical layer service data unit (PSDU) (or MAC protocol data unit (MPDU) or MAC payload). The PPDU header may include a PHY header and a PHY preamble. And, the PSDU (or MPDU) may correspond to a data unit including a frame or may correspond to a frame.

Conversely, a transmission from an STA to the AP may be referred to as an uplink transmission, and the transmission of data from multiple STAs to the AP within the same time resource may be expressed by using the term uplink multi-user transmission (or uplink multiple user transmission). A UL SU transmission may indicate an uplink transmission from one STA to one AP within the entire transmission resource. Unlike the legacy wireless LAN system, which only authorizes UL SU transmission, in the wireless LAN system according to the exemplary embodiment of the present invention, the UL MU transmission may also be supported. Each of the PPDU, frame, and data that are transmitted via uplink transmission may be respectively expressed by using the terms uplink PPDU, uplink frame, and uplink data. The uplink transmission that is performed by each of the multiple STAs may be performed within a frequency domain or a spatial domain.

In case the uplink transmission that is performed by each of the multiple STAs is performed within the frequency domain, different frequency resources corresponding to each of the multiple STAs may be allocated as uplink transmission resources based on OFDMA. Each of the multiple STAs may transmit an uplink frame to the AP by using the respective frequency resources allocated to each STA. Such transmission method using different frequency resources may also be expressed by using the term UL MU OFDMA transmission method.

In case the uplink transmission that is performed by each of the multiple STAs is performed within the spatial domain, different space time streams (or spatial streams) are allocated to each of the multiple STAs, and each of the multiple STAs may transmit an uplink frame to the AP by using different space time streams. Such as transmission method using different spatial streams may also be expressed by using the term UL MU MIMO transmission method.

A UL MU OFDMA transmission may be performed along with a UL MU MIMO transmission. For example, a UL MU MIMO transmission that is based on a plurality of space-time streams (or spatial streams) within a specific subband (or sub channel), which is allocated for the UL MU OFDMA transmission.

Hereinafter, the exemplary embodiment of the present invention discloses a PPDU format for DL MU transmission and UL MU transmission in a wireless LAN system. Hereinafter, a sub-channel is disclosed as a minimum frequency resource unit for DL MU OFDMA transmission. More specifically, an entire frequency resource may include a plurality of sub-channels. Instead of the term sub-channel, the term subband may also be used as a term for indicating the minimum frequency resource unit for the DL MU OFDMA transmission being included in the entire frequency resource. In other words, the entire frequency resource may include a plurality of channels (e.g., primary channel, secondary channel), and each of the plurality of channels may include a plurality of sub-channels.

More specifically, hereinafter, the exemplary embodiment of the present invention discloses a transmission method for a DL MU PPDU and a UL MU PPDU through each of two sub-channels (sub-channel1, sub-channel2), respectively. The usage of two sub-channels is an example of the plurality of sub-channels. Also, hereinafter, one channel having the size of 20 MHz being included in an entire bandwidth of 20 MHz and two sub-channels each having the size of 10 MHz being included in an entire bandwidth of 20 MHz are assumed in the exemplary embodiment of the present invention. However, the size of an entire band, the size of a channel, and the size of a sub-channel may vary.

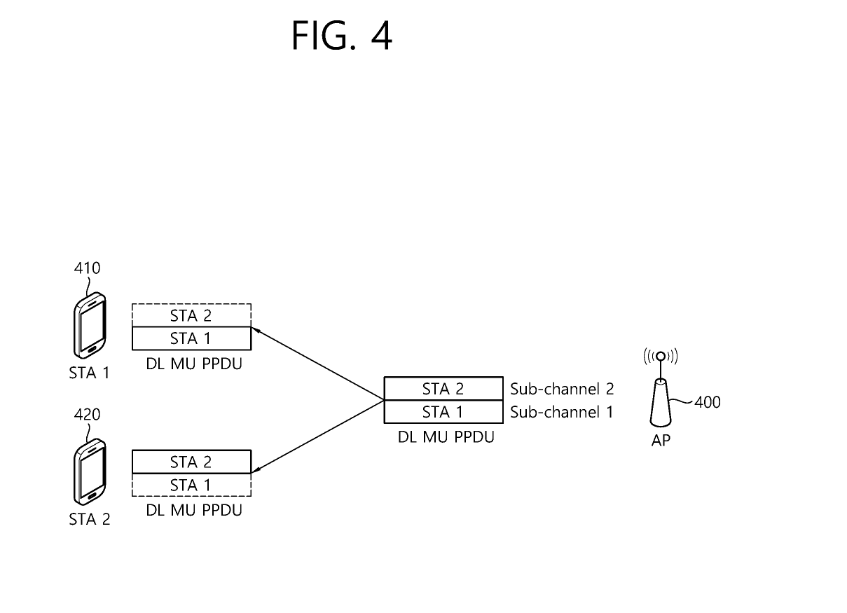

FIG. 4 is a conceptual diagram illustrating DL MU transmission according to an exemplary embodiment of the present invention.

Referring to FIG. 4, the AP 400 may transmit a DL MU PPDU to a plurality of STAs based on DL MU OFDMA transmission. The DL MU PPDU may correspond to a data unit for transmitting downlink data corresponding to each of the plurality of STAs within an overlapped time resource.

The DL MU PPDU may include a PPDU header and a MAC payload, and the PPDU header may include a legacy PPDU header and a high efficiency (HE) PPDU header. The MAC payload may also be expressed differently by using the terms frame, PSDU, and MPDU.

The legacy PPDU header may include a legacy short training field (L-STF), a legacy long training field (L-LTF), and a legacy signal field (L-SIG).

The HE PPDU header may include a plurality of signal fields (e.g., HE-SIG1 (or HE-SIG A), HE-SIG2 (or HE-SIG B), and HE-SIG3 (or HE-SIG C)) and HE-training fields (HE-STF, HE-LTF).

Part of the signal fields (e.g., HE-SIG 1) being included in the HE PPDU header of the DL MU PPDU may be transmitted in a duplicated format, which is duplicated in channel units. Also, part of the signal fields being included in the HE PPDU header may be encoded within the entire band (sub-channel1, sub-channel2) or an individual sub-channel (each of sub-channel1 and sub-channel2) and may then be transmitted.

Each of the STA1 410 and STA2 420 that has received the DL MU PPDU may decode the HE PPDU header and may then acquire information on a sub-channel that is allocated to each of the STA1 410 and STA2 420. Each of the STA1 410 and STA2 420 may decode a MAC payload, which is transmitted through the sub-channels allocated to each of the STA1 410 and STA2 420, and may then receive downlink data corresponding to each of the STA1 410 and STA2 420.

In case the DL MU OFDMA transmission as well as DL MU MIMO transmission is used in order to perform the DL MU transmission, downlink data for each of the plurality of STAs (e.g., STA1 410, STA3, STA4, STA5) may be transmitted through each of a plurality of time-spatial streams within a specific sub-channel (e.g., within sub-channel1). Hereinafter, although the DL MU PPDU format for the DL MU OFDMA transmission is disclosed for simplicity in the description, in case the DL MU MIMO is used, a downlink PPDU including a PPDU header and a MAC payload may be transmitted through a plurality of time-spatial streams within a specific sub-channel.

In case the decoding of the DL MU PPDU is successfully performed, each of the STA1 410 and STA2 420 may transmit an ACK frame (or block acknowledgement (BA) frame) to the AP 400 based on a UL SU transmission or a UL MU transmission.

Hereinafter, the exemplary embodiment of the present invention will disclose a detailed DL MU PPDU format (or structure). Also, in the DL MU PPDU, the HE-SIG1 may be expressed by using the term HE-SIG1 field (or HE-SIG A field), the HE-SIG2 may be expressed by using the term HE-SIG2 field (or HE-SIG B field), the HE-SIG3 may be expressed by using the term HE-SIG3 field (or HE-SIG C field), and the HE-SIG4 may be expressed by using the term HE-SIG4 field (or HE-SIG D field).

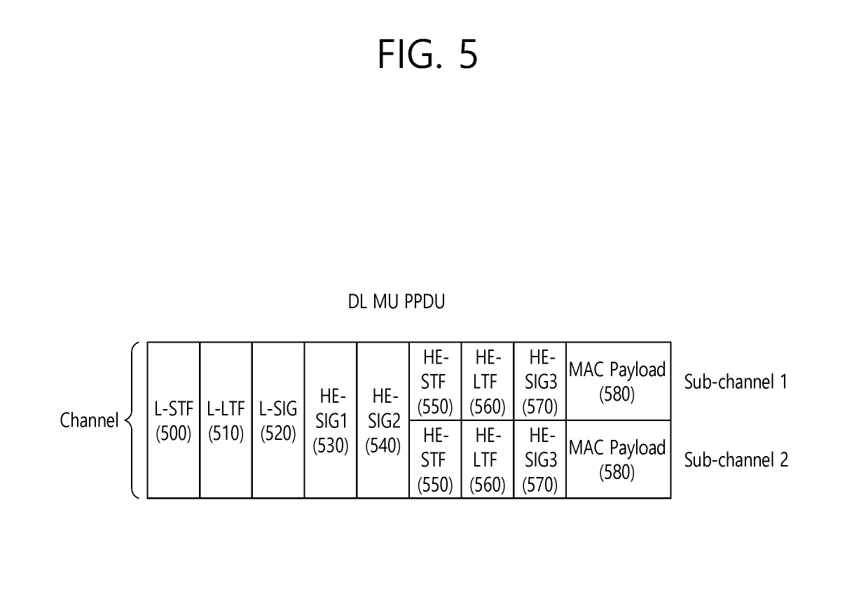

FIG. 5 is a conceptual view illustrating a DL MU PPDU according to an exemplary embodiment of the present invention.

Referring to FIG. 5, the DL MU PPDU may include a legacy PPDU header, an HE PPDU header, and a MAC payload.

The legacy PPDU header may include L-STF, L-LTF, and L-SIG.

The L-STF 500 may include a short training orthogonal frequency division multiplexing (OFDM) symbol. The L-STF 500 may be used for frame detection, automatic gain control (AGC), diversity detection, and coarse frequency/time synchronization.

The L-LTF 510 may include a long training orthogonal frequency division multiplexing (OFDM) symbol. The L-LTF 510 may be used for fine frequency/time synchronization and channel prediction.

The L-SIG 520 may be used for transmitting control information. The L-SIG 520 may include information on data transmission rate, data length, and so on.

The HE PPDU header may include an HE-SIG1 530, an HE-SIG2 540, an HE-STF 550, an HE-LTF 560, and an HE-SIG3 570.

The HE-SIG1 530 may include common information (bandwidth (BW), guard interval (GI) length, BSS index, cyclic redundancy check (CRC), tail bit, and so on) for performing decoding of the DL MU PPDU.

More specifically, the HE-SIG1 530 may include color bits for BSS identification, a bit indicating a total bandwidth size through which the DL MU PPDU is transmitted, a tail bit, a CRC bit, and a bit indicating a cyclic prefix (CP) (or guard interval (GI)) length. The bit indicating the total bandwidth size through which the DL MU PPDU is transmitted may also indicate a contiguous frequency resource or a non-contiguous frequency resource for transmitting the DL MU PPDU.

Moreover, the HE-SIG1 530 may further include information related to the HE-SIG2 540. For example, the HE-SIG1 530 may further include information on a modulation and coding scheme (MCS) being applied to the HE-SIG2 540 and information on a number of OFDM symbols being allocated for the HE-SIG2 540.

Also, the HE-SIG1 530 may also include information on a time-spatial stream. For example, the information on a time-spatial stream may include information on a number of time-spatial streams used for the transmission of the MAC payload in each of the plurality of sub-channels through which the DL MU PPDU is transmitted.

Additionally, the HE-SIG1 530 may also include information on beamforming of the time-spatial stream and information related to clear channel assessment (CCA) and power control of the STA.

The HE-SIG2 540 may include information on each of the plurality of STAs that are to receive the DL MU PPDU. For example, the HE-SIG2 540 may include identification information (e.g., partial association identifier (PAID), group identifier (GID)) of the plurality of STAs that are to receive the DL MU PPDU.

Moreover, the HE-SIG2 540 may include information on the resources being allocated to each of the plurality of STAs that are to receive the DL MU PPDU. More specifically, the HE-SIG2 540 may also include OFDMA based resource allocation information (or MU-MIMO information) corresponding to each of the plurality of STAs that are to receive the DL MU PPDU. For example, the HE-SIG2 540 may include information on an allocated sub-channel and/or allocated time-spatial stream of a field (e.g., HE-STF 550, HE-LTF 560, HE-SIG3 570, and MAC payload 580) after the HE-SIG2 540, which is transmitted to each of the plurality of STAs.

The HE-STF 550 may be used for enhancing automatic gain control estimation in a multiple input multiple output (MIMO) environment or an OFDMA environment. More specifically, the HE-STF 550 may be used for the automatic gain control estimation and channel estimation for the decoding of a field after the HE-STF 550 being transmitted through the same sub-channel as the sub-channel through which the HE-STF 550 is transmitted.

The HE-LTF 560 may be used for estimating a channel in a MIMO environment or an OFDMA environment. More specifically, the HE-LTF 560 may be used for the channel estimation for the decoding of a field after the HE-LTF 560 being transmitted through the same sub-channel as the sub-channel through which the HE-LTF 560 is transmitted.

The HE-SIG3 570 may include information for performing decoding of the MAC payload. The information for decoding the MAC payload may include MCS, Coding, space time block coding (STBC), transmit beamforming (TXBF), and so on. More specifically, the HE-SIG3 570 may include information on the MCS being applied to the MAC payload, which is transmitted through the same sub-channel as the sub-channel through which the HE-SIG3 570 is transmitted, and information on the STBC and TXBF used for the transmission of the MAC payload. The information being included in the HE-SIG3 570 may be included in the HE-SIG2 540. And, in this case, the HE-SIG3 570 may not be included in the DL MU PPDU as a separate field.

Each of the plurality of MAC payloads being included in the DL MU PPDU may include downlink data that are to be transmitted to each STA. The MAC payload may include a MAC header and a MSDU (or MAC body). The MAC header may include a duration/ID field including information corresponding to a time resource for a transmission procedure of the DL MU PPDU, an identifier of a transmitting STA transmitting the MAC payload (or frame), an identifier of a receiving STA for receiving the MAC payload (or frame), and so on. The MSDU may include downlink data. The MAC header or MSDU may also include the above-described PBAR information or PBA information. The MSDU may include downlink data that are to be transmitted to an STA pending to the AP.

According to the exemplary embodiment of the present invention, in the DL MU PPDU, the L-STF 500, the L-LTF 510, the L-SIG 520, and the HE-SIG1 530 may be encoded to a plurality of sub-channel units (or channel units). The HE-SIG1 530, which is encoded to a plurality of sub-channel units (or channel units), may be transmitted in a duplicated format within the entire bandwidth. At least one field among the L-STF 500, the L-LTF 510, and the L-SIG 520 may also be transmitted in the duplicated formatted within the entire bandwidth.

The duplicated format may be generated based on a replication (or duplication) of a field, which is transmitted within a specific band. In case a duplicated format is used, a field of a specific band may be replicated (or duplicated), and, then, the replicated (or duplicated) field may be transmitted within a plurality of bands.

The L-STF 500, the L-LTF 510, the L-SIG 520, and the HE-SIG1 530 may be encoded within a channel including the sub-channel1 and the sub-channel2 and may then be transmitted. In case the entire bandwidth through which the DL MU PPDU is being transmitted includes a plurality of channels, the L-STF 500, the L-LTF 510, the L-SIG 520, and the HE-SIG1 530, which are encoded in channel units, may also be transmitted through other channels including other sub-channels. Additionally, in case the entire bandwidth being allocated to the DL MU PPDU includes a plurality of channels, the HE-SIG1 530, which is encoded in channel units, may be replicated (or duplicated) and may then be transmitted within another channel including other sub-channels.

The HE-SIG2 540 may be encoded and transmitted to the DL MU PPDU through the entire allocated band. For example, in case the entire allocated band allocated to the DL MU PPDU is equal to 40 MHz, the HE-SIG2 540 may be encoded and transmitted in the 40 MHz band. In FIG. 5, a case when the entire band that is allocated to the DL MU PPDU is equal to 20 MHz is assumed. According to another exemplary embodiment of the present invention, the HE-SIG2 540 may be encoded and transmitted in channel units through the entire band being allocated to the DL MU PPDU. For example, in case the size of the channel band is equal to 20 MHz, the HE-SIG2 540 may be encoded and transmitted in band units of 20 MHz. In case the HE-SIG2 is encoded in channel units, the HE-SIG2 may include only information corresponding to an STA group receiving the DL MU PPDU through a specific channel among the plurality of STAs receiving the DL MU PPDU. More specifically, the HE-SIG2 may include identification information of the STA group receiving the DL MU PPDU within a channel through which the HE-SIG2 is transmitted, and resource allocation information corresponding to an STA being included in the STA group.

The HE-STF 550, the HE-LTF 560, and the HE-SIG3 570 may be encoded and transmitted within a frequency resource (sub-channel) that is allocated to each of the plurality of STAs receiving downlink data through the DL MU PPDU. For example, a case when each of the sub-channel1 and the sub-channel2 is respectively allocated to the STA1 and the STA2 may be assumed. In this case, the HE-STF 550, the HE-LTF 560, and the HE-SIG3 570 may be encoded in each of the sub-channel1 and the sub-channel2 and may be transmitted to each of the STA1 and the STA2. The HE-STF 550, the HE-LTF 560, and the HE-SIG3 570 being transmitted through each of the sub-channel1 and the sub-channel2 may include separate training field information and control information for the decoding of a MAC payload 580 of each of the STA1 and the STA2.

The STA1 and the STA2 may receive the L-STF 500, the L-LTF 510, the L-SIG 520, and the HE-SIG 530. The L-STF 500 and the L-LTF 510 may be used for the decoding of the L-SIG 520 and the HE-SIG1 530 and the HE-SIG2 540. The STA1 and the STA2 may acquire information on the entire bandwidth (e.g., 40 MHz) through which the HE-SIG2 540 is transmitted based on the bandwidth information included in the HE-SIG1 530. Each of the STA1 and the STA2 may acquire information corresponding to the resource (e.g., sub-channel) being allocated to each of the STA1 and the STA2, which is included in the HE-SIG2 540, and, then, each of the STA1 and the STA2 may receive the HE-STF 550, the HE-LTF 560, the HE-SIG3 570, and the MAC payload 580, which are transmitted through an allocated sub-channel.

The HE-STF 550 and the HE-LTF 560 may be used for channel estimation for performing the decoding of the HE-SIG3 570 and the MAC payload 580. Each of the STA1 and the STA2 may perform decoding on the MAC payload 580, which is transmitted through an allocated sub-channel based on the HE-STF 550, the HE-LTF 560, and the HE-SIG3 570.

According to the exemplary embodiment of the present invention, among the fields (MAC header fields) included in the MAC header of the MAC payload, at least one field may be included in the PPDU header. The MAC header field is disclosed in 8.2.4 Frame fields of IEEE P802.11-REVmcTM/D3.1 Draft Standard for Information technology Telecommunications and information exchange between systems Local and metropolitan area networks Specific requirements Part 11: Wireless LAN Medium Access Control (MAC) and Physical Layer (PHY) Specifications.

In case the PPDU header includes all of the MAC header fields, the overhead of the PPDU header may become large. Therefore, only MAC header fields that are required depending upon the corresponding situation may be selectively included in the PPDU header. For example, among the fields included in the MAC header, at least one field (e.g., duration/ID field) may be included in the RE-SIG2. HE-SIG1, which is transmitted prior to the RE-SIG2, may include a MAC indicator field (or MAC information indicator) indicating a MAC header field, which is included in the PPDU header in the RE-SIG2. The MAC indicator field may indicate a MAC header field being included in the RE-SIG2.

The MAC header field that may be included in the PPDU header may include at least one of a frame control field, a duration/ID field, address1 field, address2 field, address3 field, address4 field, a sequence control indicator field, a quality of service (QoS) field, and a high throughput (HT) field. For simplicity in the description, a case when at least one MAC header field is included in the PPDU header as a field unit will be disclosed herein. However, instead of a field unit, information being included in one MAC header field, each of a plurality of information sets being included in a plurality of MAC headers may be combined to be defined as a newly defined field, and the newly defined field may be included in the PPDU header.

Hereinafter, a MAC header field that can be included in the PPDU header will be disclosed.

The frame control field may include control information associated with a frame that is being transmitted.

As a sub-field, the frame control field may include a protocol version field, a frame type field, a frame sub-type field, a To DS field, a From DS field, a More flag field, a Retry field, a Power management field, a MoreData field, a Protected frame field, and an order field.

The protocol version field may include information on a protocol version of the current wireless LAN system.

The frame type field may include information on a frame type (management frame, control frame, and data frame).

The frame sub-type field may include information for indicating individual frames (e.g., association request frame, association response frame, and so on).

The To DS field and the From DS field may be used for the interpretation of the address fields (address1 field, address2 field, address3 field, address4 field) being included in the MAC header.

The More flag field may include information indicating the presence or absence of contiguous fragments within the same MSDU.

The Retry field may include information indicating whether or not the data correspond to re-transmission data.

The Power management field may include information indicating a power management mode (power save mode or active mode) of an STA.

The MoreData field may include information on the presence or absence of pending downlink data that are to be additionally transmitted to an STA operating in a power save mode.

The Protected frame field may include information on whether or not encryption is performed on the data of the corresponding frame.

The order field may include information associated with re-assembly of fragmented data.

The duration/ID field may include information on a duration for the transmission of the corresponding frame and information on an association identifier (AID) of the corresponding STA.

The address1 field, the address2 field, the address3 field, and the address4 field may include information on a source address (SA), a destination address (DA), a basic service set identifier (BSSID), a receiver address (RA), and a transmitter address (TA).

The sequence control indicator field may include a sequence number field and a fragmentation number field. The sequence number field may include information on an allocated sequence number corresponding to a MSDU, an A-MSDU, and a MAC management protocol data unit (MMPDU). The fragmentation number field may include fragmentation number information that is allocated to each fragment of the MSDU and the MMPDU.

The QoS control field may include information on a traffic identifier (TID), an end of service period (EOSP), an ACK policy, and a transmission opportunity (TXOP) limit).

The HT control field may include a VHT sub-field, a link adaptation sub-field, a calibration position sub-field, a calibration sequence sub-field, a channel state information/steering (CSI/Steering) sub-field, a null data packet announcement (NDP Announcement) sub-field, an access category constraint (AC Constraint) sub-field, a reverse direction grant (RDG)/more PPDU sub-field, and a reserved sub-field.

The link adaptation sub-field may include a training request (TRQ) sub-field, a modulation and coding scheme (MCS) request or antenna selection (ASEL) indication (MAI) sub-field, a MCS feedback sequence identifier (MFSI) sub-field, and a MCS feedback and antenna selection command/data (MFB/ASELC) sub-field.

The TRQ sub-field is set to 1, when a sounding PPDU transmission is requested to a responder, and the TRQ sub-field is set to 0, when a sounding PPDU transmission is not requested to the responder. Also, when the MAI sub-field is set to 14, this indicates an ASEL indication, and the MFB/ASELC sub-field may be interpreted as antenna selection command/data. Otherwise, the MAI sub-field indicates an MCS request, and the MFB/ASELC sub-field is interpreted as an MCS feedback. In case the MAI sub-field indicates a MCS Request (MRQ), in case no MCS feedback is requested, the MAI sub-field is set to 0, and, in case an MCS feedback is requested, the MAI sub-field is set to 1. The sounding PPDU may correspond to a PPDU carrying a training symbol, which may be used for channel estimation.

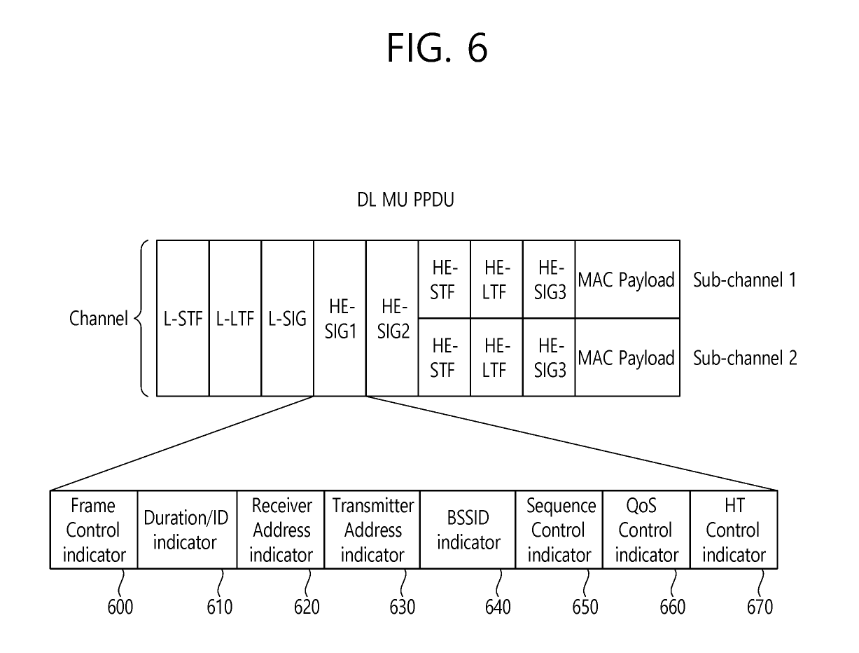

FIG. 6 is a conceptual view illustrating a MAC indicator field included in a PPDU header according to an exemplary embodiment of the present invention.

FIG. 6 discloses a MAC indicator field for indicating a MAC header field, which is included in the PPDU header of a DL MU PPDU.

The MAC indicator field may include a sub-indicator for indicating a MAC header field that is included in the PPDU header.

The MAC indicator field may include a frame control indicator 600, a duration/ID indicator 610, a receiver address indicator 620, a transmitter address indicator 630, a basic service set identifier (BSSID) indicator 640, a sequence control indicator 650, a quality of service (QoS) control indicator 660, and a high throughput (HT) control indicator 670.

In FIG. 6, an exemplary indicator for indicating the MAC header field that may be included in the PPDU header is disclosed. A number indicators or type of indicators for indicating the MAC header field may vary depending upon the number and type of MAC header fields being included in the PPDU header.

Referring to FIG. 6, the frame control indicator 600 may indicate whether or not a frame control field of the MAC header is included in the PPDU header.

The frame control indicator 600 may indicate whether or not a frame control field is included in the PPDU header. For example, in case the frame control indicator 600 is set to 1, this may indicate whether or not a frame control field is included in the PPDU header. An STA that has received the frame control field being included in the PPDU header may acquire information on the frame type prior to the decoding of the MAC header and may then prepare for the next operation in advance. For example, in case the frame control indicator 600 indicates a data frame, the STA may configure in advance an acknowledgement (ACK) frame (or block acknowledgement (BA) frame), which is to be transmitted as a response to the data frame. As another example, in case that STA has already transmitted a data frame, the STA may determine in advance whether or not to perform re-transmission of a data frame in accordance with whether the frame control indicator 600 indicates an ACK frame/BA frame, which is transmitted as a response to the data frame.

As yet another example, in case the frame control indicator 600 being included in the PPDU header indicates a request to send (RTS) frame, the STA may analyze in advance a clear channel assessment (CCA) result in multiple channels and may then determine a channel through which a clear to send (CTS) frame is to be transmitted.

More specifically, in case the STA has acquired in advance the information on the frame type from the PPDU header, the STA may prepare in advance for the operations for performing the next procedure. Accordingly, processing delay in the STA may be reduced.

The duration/ID indicator 610 may indicate whether or not a duration/ID field is included in the PPDU header. For example, in case the duration/ID indicator 610 is set to 1, this may indicate that a duration/ID field is included in the PPDU header.

In case a frame that is received by the STA corresponds to a frame being transmitted by another STA, a TXOP of the other STA may be protected by configuring a network allocation vector (NAV) based on the duration/ID field that is included in the PPDU header. More specifically, in case the receiver address field being included in the PPDU header does not indicate the address of the STA, the STA may configure a NAV based on the duration information that is included in the duration/ID field, and, then, the STA may recognize the medium to be busy. More specifically, in case the STA configures (or sets up) a NAV, a value of a NAV timer is set (or configured), and, then, access to a medium by the STA during a predetermined period of time, which corresponds to the configured NAV timer value, may be delayed. Also, the STA may be operated in the power save mode during the NAV set-up period, and the power consumption of the STA may be reduced. More specifically, in case the duration/ID field is included in the PPDU header, the STA may be quickly shifted to the power save mode, thereby allowing the power of the STA to be saved and preventing interframe collision.

The receiver address indicator 620 may indicate whether or not a receiver address field is included in the PPDU. The receiver address indicator 620 may include identification information of an STA that is to receive the PPDU (or frame) (or a MAC address of the receiving STA). For example, in case the receiver address indicator 620 is set to 1, a receiver address field may be included in the PPDU header. In case a receiver address field is included in the PPDU header, the STA may decode the PPDU header and, may then determine whether or not to perform additional decoding on the PPDU. For example, in case the receiver address field included in the PPDU header indicates an STA, the STA may periodically perform decoding on the MAC payload. Conversely, in case the receiver address field included in the PPDU header does not indicate an STA, the STA may not perform decoding on the MAC payload. The STA may configure a NAV in advance prior to the decoding of the MAC header based on the duration/ID field, which is included in the PPDU header, and may then be operated in the power save mode.

The transmitter address indicator 630 may indicate whether or not a transmitter address field is included in the PPDU. The transmitter address indicator may include identification information of an AP that has transmitted the PPDU (or frame) (or a MAC address of the transmitting STA). In case the transmitter address indicator 630 is set to 1, a transmitter address field may be included in the PPDU header. The STA that has received the PPDU acquire in advance information on the AP that has transmitted the PPDU prior to the decoding of the MAC header based on the transmitter address field, which is included in the PPDU header.

An STA, which is associated with a specific AP and which does not perform any separate inter-STA communication, may acquire information corresponding to whether or not the PPDU corresponds to a PPDU (or frame) that is transmitted from an AP, which is associated with the STA, based on the transmitter address field being included in the PPDU header. In case the information included in the transmitter address field is different from the identification information of the AP being associated with the STA, the STA may configure a NAV prior to the decoding of the MAC payload and may then be operated in the power save mode.

The BSSID indicator 640 may indicate whether or not a BSSID field is included in the PPDU. The BSSID indicator 640 may include information on a BSSID of a BSS including the transmitting STA, which has transmitted the PPDU. The STA may acquire information on the BSS including the transmitting STA, which has transmitted the PPDU, based on the BSSID field being included in the PPDU header. Prior to the decoding of the MAC header, the STA may consider in advance whether or not the BSSID of the transmitting STA is identical to the BSSID of the STA and may then differently configure the respective CCA threshold values (or CCA sensitivity levels). The CCA sensitivity level may be used for determining whether the medium of the STA is idle/busy. For example, in case the STA senses the medium, and, in case the sensed result is lower than the CCA sensitivity level, the STA may determine the medium to be idle. Conversely, in case the STA senses the medium, and, in case the sensed result is equal to or higher than the CCA sensitivity level, the STA may determine that the medium is busy.

For example, in case the STA senses whether the medium is idle/busy based on a reception intensity of a PPDU being transmitted from another BSS, the STA may determine whether the medium is idle/busy based on a first CCA intensity level. Also, in case the STA senses whether the medium is idle/busy based on a reception intensity of a PPDU being transmitted from another BSS, the STA may determine whether the medium is idle/busy based on a second CCA intensity level. At this point, the first CCA intensity level may correspond to a value that is smaller than the second CCA intensity level.

The sequence control indicator 650 may indicate whether or not a sequence control field is included in the PPDU header. In case the sequence control indicator 650 is set to 1, the PPDU header may include the sequence control indicator 650. In case the PPDU carries a block ACK frame or a block ACK request frame, the STA may acquire in advance information on a sequence of data being included (or that are to be included) in the PPDU based on the decoding of a sequence control field being included in the PPDU header. Accordingly, the STA may perform processing in advance in a buffer prior to the decoding of the MAC header based on the sequence control field being included in the PPDU and may then gain time to access a memory.

The QoS control indicator 660 may indicate whether or not a QoS control field is included in the PPDU header. In case the QoS control indicator 660 is set to 1, the PPDU may include a QoS control field. The a QoS control field may include information on an ACK Policy. Therefore, the STA may acquire the ACK policy based on a QoS control field of the PPDU header and may then perform in advance operations in accordance with the ACK Policy prior to the decoding of the MAC header. For example, in case the ACK policy indicated based on the QoS control field of the PPDU header corresponds to No ACK, the STA is not required to prepare in advance an ACK frame. Depending upon whether the ACK policy indicated based on the QoS control field of the PPDU header corresponds to a delayed ACK or an immediate ACK, the STA may determine whether or not to disperse (or scatter) a load for generating an ACK frame in the MAC layer. In case the ACK policy corresponds to a delayed ACK, the processing of the STA for generating an ACK frame may be postponed (or delayed) to a relatively later order than the case when the ACK policy corresponds to the immediate ACK transmission.

The HT control indicator 670 may indicate whether or not an HT control field is included in the PPDU header. In case the HT control indicator 670 is set to 1, the PPDU header may include an HT control field. The HT control field may include information related to feedback. In case the STA acquires in advance an HT control field based on the decoding of the PPDU header prior to the decoding of the MAC header, the STA may perform in advance processing that is related to rate adaptation.

For simplicity in the description, FIG. 6 disclosed an exemplary case when the MAC indicator field is included in the HE-SIG1 and when control information being indicated based on the MAC indicator field is included in the HE-SIG2. Each of the MAC indicator field and the control information being indicated based on the MAC indicator field may be included in the PPDU header in diverse formats. Additionally, as described above, an indicator being included in the MAC indicator field and a MAC header field (or control information) being indicated based on the MAC indicator field and then included in the PPDU header may vary.

For example, each set of control information (or each MAC header field), which is indicated based on the MAC indicator field in accordance with the characteristics of a load situation (or status) of the STA, a processing performance of the STA, a request of the STA, a channel situation (or status), and a frame transmission/reception procedure, and which is then included in the DL MU PPDU, may be adaptively changed (or varied). In case the load of the STA is large, the AP may include a MAC header field for quickly determining whether or not to stop the decoding of the STA on the DL MU PPDU in order to allow the STA to quickly determine whether or not to stop the decoding. The control information (or a MAC header field) included in the DL MU PPDU may be determined based on information on the load of the STA, which is transmitted to the AP by the STA. Alternatively, the STA may request the AP to include and transmit a specific set of MAC header information in the DL MU PPDU.

As another example, in case the processing performance of the STA is decreased, the AP may include and transmit in advance a MAC header field for determining whether or not to end a decoding process in the DL MU PPDU.

As yet another example, the AP may selectively determine a required MAC header field in accordance with the transmit transmission/reception procedure and may then include and transmit the corresponding MAC header field in the DL MU PPDU. For example, the PPDU header of the DL MU PPDU being transmitted when the frame transmission and reception procedures are ended may not include separate duration/ID field, BSSID indicator field, QoS control indicator field, HT control indicator field, and so on.

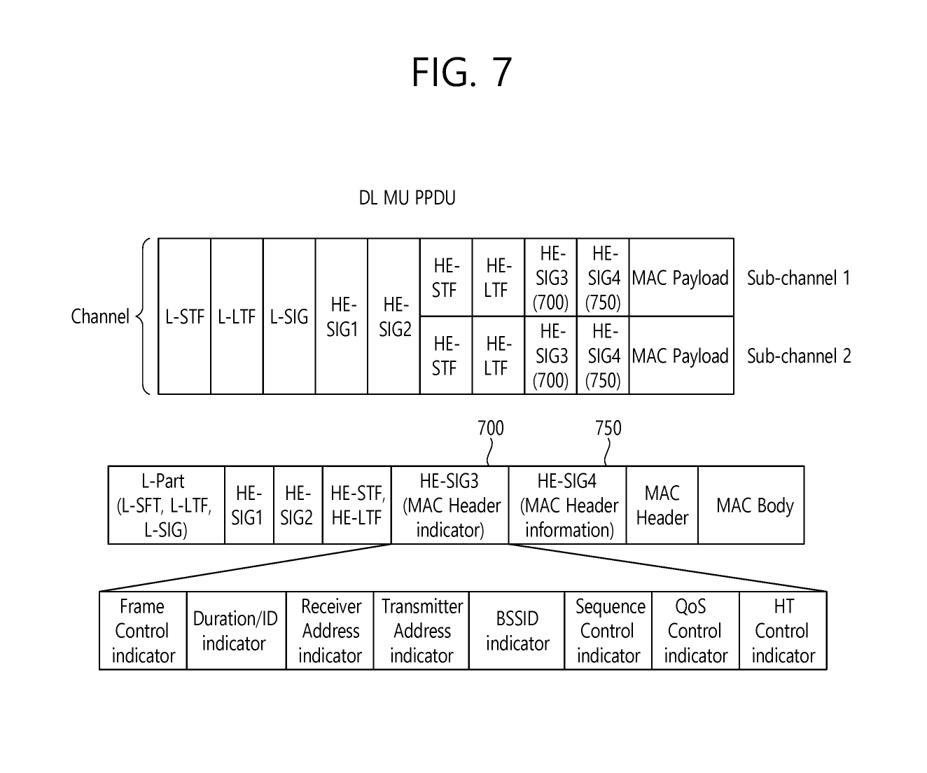

FIG. 7 is a conceptual view illustrating a DL MU PPDU format according to an exemplary embodiment of the present invention.

FIG. 7 discloses a DL MU PPDU format including a separate signal field, which includes control information being indicated based on the MAC indicator field.

Referring to FIG. 7, in the DL MU PPDU format, the MAC indicator field may be included in one signal field (e.g., HE-SIG3 700) among the remaining signal fields excluding HE-SIG4 750.

According to the exemplary embodiment of the present invention, the HE-SIG4 750, which corresponds to a separate signal field including the control information being indicated based on the MAC indicator field, may be defined. The HE-SIG4 750 may be positioned in a time-based position after the HE-SIG3 700.

For example, the HE-SIG3 700 may include a MAC indicator field, and the HE-SIG4 750 may include a frame control field, a duration/ID field, a receiver address field, a transmitter address field, a BSSID field, a sequence control field, a QoS control field, and an HT control field.

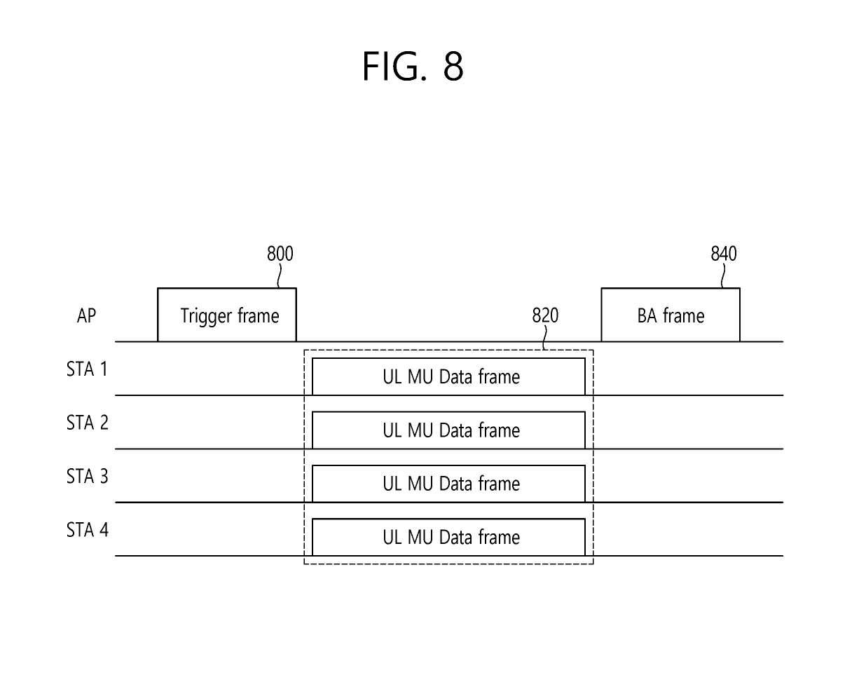

FIG. 8 is a conceptual diagram illustrating UL MU transmission according to an exemplary embodiment of the present invention.

Referring to FIG. 8, an uplink transmission of a plurality of STAs is disclosed.

The AP may transmit a trigger frame 800 to a plurality of STAs in order to guide the uplink transmission of the plurality of STAs.

Based on the transmission of the trigger frame 800 performed by the AP, a TXOP duration, which corresponds to a time resource for the UL MU transmission procedure, may be acquired.

The trigger frame 800 may include information for the transmission of a UL MU PPDU 820 performed by each of the plurality of STAs. The plurality of STAs to which the transmission of the UL MU PPDU 820 is guided based on the trigger frame 800 may be expressed by using the term UL MU target STA.

For example, the trigger frame 800 may include resource allocation information corresponding to each of the plurality of UL MU target STAs, identification information of each of the plurality of UL MU target STAs, information on a MCS being applied to the UL MU PPDU 820, which is being transmitted by each of the plurality of UL MU target STAs, information on a MU type (OFDMA, MIMO) of the UL MU PPDU 820, which is being transmitted by each of the plurality of UL MU target STAs, and so on.

Also, the trigger frame 800 may further include information on the transmission power of the UL MU PPDU 820, space time block coding (STBC) that is to be used for the transmission of the UL MU PPDU 820, and information on beamforming.

Each of the UL MU target STAs that has received the trigger frame 800 may transmit the UL MU PPDU 820 to the AP based on an interframe space, which is referred to as a short interframe space (SIFS). For example, each of the plurality of UL MU target STAs that has received the trigger frame 800 may receive the trigger frame 800 and may transmit the UL MU PPDU 820 to the AP after a SIFS.

The AP may transmit may transmit a block ACK frame 840 corresponding to the UL MU PPDU 820, which is received from the plurality of UL MU target STAs, to the plurality of UL MU target STAs.

More specifically, the STA may receive a trigger frame from the AP, and the STA may transmit the UL MU PPDU to the AP through a sub-channel as a response to the received trigger frame. At this point, the trigger frame may include UL MU identification information and UL MU resource allocation information. The UL MU identification information may include identification information of the STA and identification information of another STA transmitting another UL MU PPDU within a time resource that overlaps with the STA, and the UL MU resource allocation information may include information on a sub-channel and information on another sub-channel for the transmission of another UL MU PPDU.

According to the exemplary embodiment of the present invention, the PPDU header of the UL MU PPDU may include a MAC indicator field and at least one MAC header field. The MAC indicator field may include at least one sub-indicator, and each of the at least one sub-indicator may indicate the presence or absence of each of the at least one MAC header field, and each of the at least one MAC header field may correspond to each of at least one field being included in the MAC header of the UL MU PPDU.

Hereinafter, the exemplary embodiment of the present invention will disclose a detailed format (or structure) of the UL MU PPDU 820.

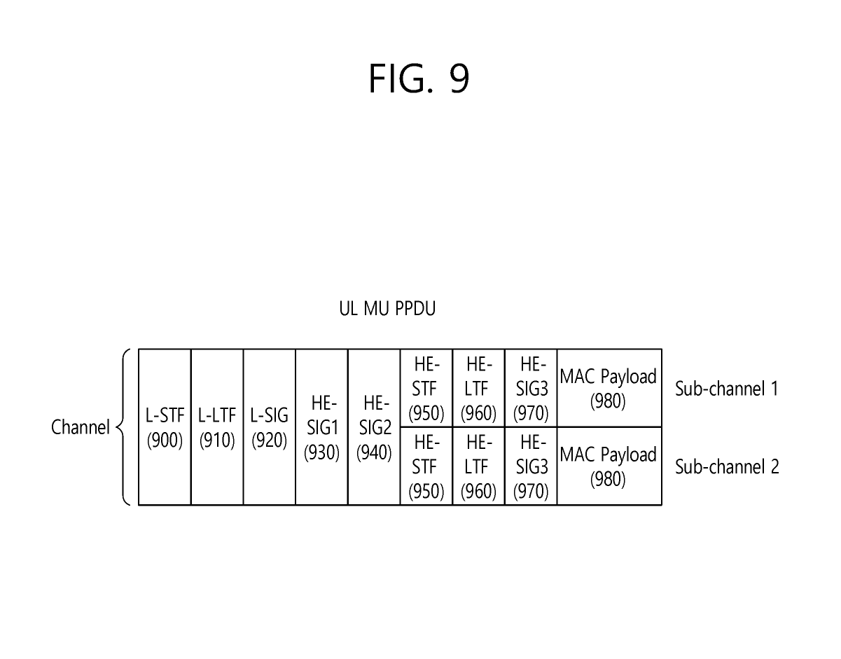

FIG. 9 is a conceptual view illustrating a UL MU PPDU according to an exemplary embodiment of the present invention.

FIG. 9 discloses a UL MU PPDU format that is transmitted by a plurality of UL MU target STAs through an entire band being allocated to the plurality of UL MU target STAs. The UL MU PPDU, which is disclosed in FIG. 9, is disclosed in the viewpoint of the AP. More specifically, the UL MU PPDU, which is disclosed in FIG. 9, may include each of a plurality of UL MU PPPDU being transmitted by each of a plurality of UL MU target STAs.

Referring to FIG. 9, the UL MU PPDU may include a PPDU header (legacy PPDU header, HE PPDU header) and a MAC payload.

The legacy PPDU header may include L-STF 900, L-LTF 910, and L-SIG 920.

Each of the L-STF 900, the L-LTF 910, and the L-SIG 920 of the UL MU PPDU may perform the same functions as each of the L-STF, the L-LTF, and the L-SIG of the DL MU PPDU. For example, the L-STF 900 and the L-LTF 910 may be used for the channel prediction for performing decoding on a field that is transmitted later on. The L-SIG 920 may information control information, such as information on the data transmission rate and data length.

The HE PPDU header may include HE-SIG1 930, HE-STF 940, HE-LTF 950, and HE-SIG3 960.

The HE-SIG1 930 may include common information (BW, GI length, BSS index, cyclic redundancy check (CRC), tail bit, and so on) for performing decoding of the UL MU PPDU. More specifically, the HE-SIG1 930 may include color bits for BSS identification, a bit indicating a total size of the bandwidth through which the UL MU PPDU is transmitted, a tail bit, a CRC bits, and a bit indicating CP (or GI) length. Part of the information being included in the HE-SIG1 930 may be determined based on control information for the UL MU transmission, which is included in a trigger frame.

The L-STF 900, the L-LTF 910, the L-SIG 920, and the HE-SIG1 930 may be encoded and transmitted in channel units. In FIG. 9, a channel having the size of 20 MHz is assumed, and the L-STF 900, the L-LTF 910, the L-SIG 920, and the HE-SIG1 930 may be encoded and transmitted in 20 MHz units.

The HE-SIG2 940 may be encoded and transmitted within the entire bandwidth. The entire bandwidth may correspond to an entire frequency bandwidth that is allocated by the trigger frame for the transmission of the UL MU PPDU by each of the plurality of UL MU target STAs. In FIG. 9, the entire bandwidth size (or total bandwidth size) may be equal to 20 MHz, and the HE-SIG2 940 may be encoded and transmitted in 20 MHz units.

The HE-SIG2 940 may include information on each of the plurality of UL MU target STAs transmitting the UL MU PPDU based on the trigger frame. For example, the HE-SIG2 940 may include identification information (e.g., PAID, GID) of a plurality of UL MU target STAs that are to transmit the UL MU PPDU. Also, the HE-SIG2 940 may include information on resource being allocated to each of the plurality of UL MU target STAs for the transmission of the HE-STF 950, the HE-LTF 960, the HE-SIG3 970, and the MAC payload 980 by each of the plurality of UL MU target STAs within the UL MU PPDU. The UL MU target STA may generate the HE-SIG2 940 based on information included in the trigger frame (e.g., identification information of the UL MU target STA, information on a resource being allocated to the UL MU target STA).

According to another exemplary embodiment of the present invention, the HE-SIG2 940 may also be encoded in channel units and then transmitted, and the HE-SIG2 940 may also include only the identification information of the UL MU target STA being allocated to sub-channels included in the channel and the allocation information of each of the sub-channels included in the channel.

According to yet another exemplary embodiment of the present invention, the UL MU PPDU may not include the HE-SIG2 940. Information indicating each of the plurality of UL MU target STAs and resource allocation information corresponding to each of the plurality of UL MU target STAs may be transmitted through a trigger frame, which is transmitted by the AP. The information indicating each of the plurality of UL MU target STAs and the resource allocation information corresponding to each of the plurality of UL MU target STAs may correspond to information that are determined by the AP. Therefore, the AP is not required to receive the information indicating each of the plurality of UL MU target STAs and the resource allocation information corresponding to each of the plurality of UL MU target STAs through the HE-SIG2 940. Therefore, the UL MU PPDU may not include the HE-SIG2 940.

In the UL MU PPDU, each of the HE-STF 940, the HE-LTF 950, the HE-SIG3 960, and the MAC payload 970 may be included in each of the plurality of sub-channels and may then be transmitted.

Each of the HE-STF 940 and the HE-LTF 950 of the UL MU PPDU may perform the same functions as each of the HE-STF and the HE-LTF of the DL MU PPDU. For example, the HE-STF 940 and the HE-LTF 950 may be used for channel estimation for performing the decoding of a field that is transmitted within the same sub-channels as the sub-channels through which the HE-STF 940 and the HE-LTF 950 are transmitted.

The HE-SIG3 960 may include information for performing decoding of the MAC payload 970. The information for decoding the MAC payload 970 may include MCS, Coding, STBC, TXBF, and so on. More specifically, the HE-SIG3 960, which is transmitted through each of the plurality of sub-channels, may include information on the MCS being applied to the MAC payload 970, which is transmitted through each of the plurality of sub-channels, and information on the STBC and TXBF used for the transmission of the MAC payload 970.

In FIG. 9, although the UL MU PPDU including the HE-SIG3 960 is assumed, information (MCS, Coding, STBC, TXBF, and so on) being included in the HE-SIG3 960 may correspond to the same information as the information being determined by the AP and then transmitted through the trigger frame. Therefore, the HE-SIG3 960 may also not be included in the UL MU PPDU.

The MAC payload 970 may include uplink data of a UL MU target STA that is triggered by the AP.

A case when the AP allocates each of the sub-channel 1 and the sub-channel2 to each of UL MU target STA1 and UL MU target STA2 based on the trigger frame and triggers uplink transmission may be assumed herein.

The AP may receive the L-STF 900, the L-LTF 910, the L-SIG 920, and the HE-SIG1 930, which are transmitted within the channel. Also, AP may receive the HE-STF 940, the HE-LTF 950, the HE-SIG3 960, and the MAC payload 970, which are transmitted by each of the STA1 and the STA2 through each of the sub-channel1 and the sub-channel2.

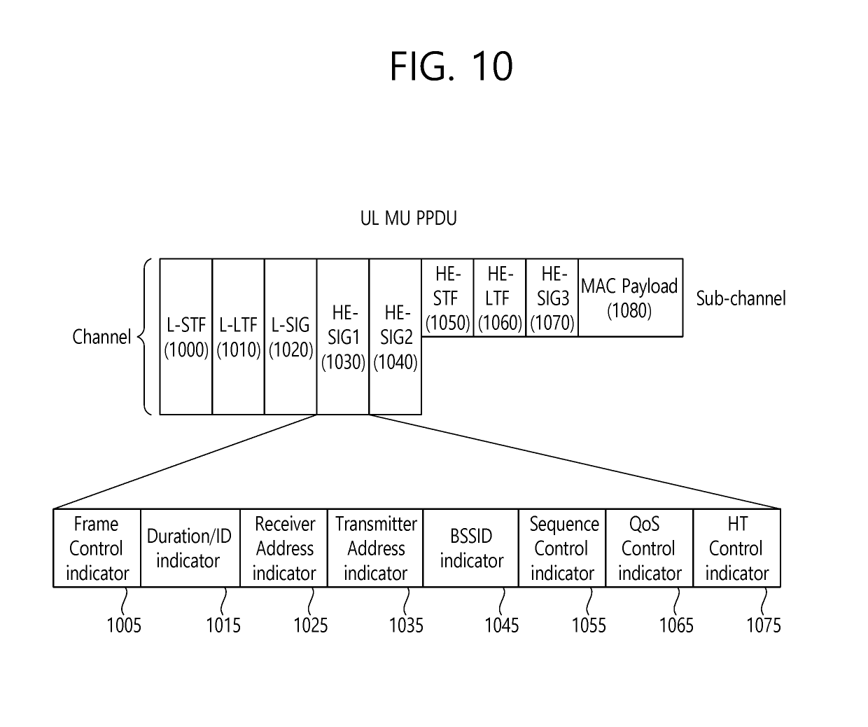

FIG. 10 is a conceptual view illustrating a UL MU PPDU being transmitted by a UL MU target STA according to an exemplary embodiment of the present invention.

FIG. 10 discloses a UL MU PPDU being transmitted by one UL MU target STA among a plurality of UL MU target STAs. The UL MU PPDU, which is disclosed in FIG. 10, is disclosed in the viewpoint of the STA. More specifically, the UL MU PPDU that is disclosed in FIG. 10 may correspond to a UL MU PPDU that is transmitted by one UL MU target STA.

In FIG. 10, a case when the AP allocates each of the sub-channel 1 and the sub-channel2 to each of UL MU target STA1 and UL MU target STA2 based on the trigger frame and triggers uplink transmission may be assumed.

Referring to FIG. 10, the UL MU target STA1 may transmit UL MU PPDU1 as a response to the trigger frame. The UL MU PPDU1 may include L-STF 1000, L-LTF 1010, L-SIG 1020, HE-SIG1 1030, and HE-SIG2 1040, which are transmitted through the channel, and HE-STF 1050, HE-LTF 1060, HE-SIG3 1070, and MAC payload 1080, which are transmitted through sub-channel1 being included in the channel.

By using the same method, the UL MU target STA2 may transmit UL MU PPDU2 as a response to the trigger frame. The UL MU PPDU2 may include the L-STF, L-LTF, L-SIG, HE-SIG1, and HE-SIG2, which are transmitted through the channel, and the HE-STF, HE-LTF, HE-SIG3, and MAC payload, which are transmitted through sub-channel2 being included in the channel. The L-STF 1000, the L-LTF 1010, the L-SIG 1020, the HE-SIG1 1030, and the HE-SIG2 1040, which are transmitted by UL MU target STA1, and the L-STF, the L-LTF, the L-SIG, the HE-SIG1, and the HE-SIG2, which are transmitted by UL MU target STA2, may include the same information and may be transmitted through the same channel. Alternatively, each of the L-STF 1000, the L-LTF 1010, the L-SIG 1020, and the HE-SIG1 1030, which are transmitted by UL MU target STA1, and the L-STF, the L-LTF, the L-SIG, the HE-SIG1, which are transmitted by UL MU target STA2, may each include different information and may each be coded by a different orthogonal code and may be transmitted through the same channel.

According to the exemplary embodiment of the present invention, a MAC header field for indicating MAC header information may also be included in the PPDU header of a UL MU PPDU.

The MAC indicator field may include a sub-indicator for indicating a MAC header field that is included in the PPDU header, among a plurality of MAC header fields.

The MAC indicator field may include a frame control indicator 1005, a duration/ID indicator 1015, a receiver address indicator 1025, a transmitter address indicator 1035, a BSSID indicator 1045, a sequence control indicator 1055, a QoS control indicator 1065, and an HT control indicator 1075.

The frame control indicator 1005 may indicate whether or not a frame control field is included in the PPDU header. For example, in case the frame control indicator 1005 is set to 1, this may indicate whether or not a frame control field is included in the PPDU header. An AP that has received the frame control field being included in the PPDU header may acquire information on the frame type prior to the decoding of the MAC header and may then prepare for the next operation in advance. For example, in case the frame control indicator 1005 indicates a data frame, the AP may configure in advance an ACK frame, which is to be transmitted as a response to the data frame. As another example, in case that AP has already transmitted a data frame, the AP may determine in advance whether or not to perform re-transmission of a data frame in accordance with whether the frame control indicator 1005 indicates an ACK frame/BA frame, which is transmitted as a response to the data frame.

As yet another example, in case the frame control indicator 1005 being included in the PPDU header indicates a RTS frame, the AP may analyze in advance a clear channel assessment (CCA) result in multiple channels and may then determine a channel through which a CTS frame is to be transmitted.

More specifically, in case the AP has acquired in advance the information on the frame type from the PPDU header, the AP may prepare in advance for the operations for performing the next procedure. Accordingly, processing delay in the AP may be reduced.

The duration/ID indicator 1015 may indicate whether or not a duration/ID field is included in the PPDU header. For example, in case the duration/ID indicator 1015 is set to 1, this may indicate that a duration/ID field is included in the PPDU header.

For example, in case the STA transmitted a PS-poll frame in order to request a pending frame to the AP, the AP may verify that the received frame corresponds to a PS-poll frame based on the frame control indicator 1005 of the PPDU header of the PPDU carrying the PS-poll, which is transmitted by the STA, and, then, the AP may generate in advance a PPDU including downlink data that are pending to the STA based on information on an AID of the STA being included in the duration/ID indicator 1015 of the PPDU header.

The receiver address indicator 1025 may indicate whether or not a receiver address field is included in the PPDU. The receiver address indicator 1025 may include identification information of an AP that is to receive the PPDU (or frame) (or a MAC address of the AP). For example, in case the receiver address indicator 1025 is set to 1, a receiver address field may be included in the PPDU header. In case a receiver address field is included in the PPDU header, the AP may decode the PPDU header and, may then determine whether or not to perform additional decoding on the PPDU. For example, in case the receiver address field included in the PPDU header indicates an AP, the AP may periodically perform decoding on the MAC payload. Conversely, in case the receiver address field included in the PPDU header does not indicate an AP, the AP may not perform decoding on the MAC payload.

The transmitter address indicator 1035 may indicate whether or not a transmitter address field is included in the PPDU. The transmitter address indicator may include identification information of an STA that has transmitted the PPDU (or frame) (or a MAC address of the transmitting STA). In case the transmitter address indicator 1035 is set to 1, a transmitter address field may be included in the PPDU header. The AP that has received the PPDU acquire in advance information on the transmitting STA that has transmitted the PPDU prior to the decoding of the MAC header based on the transmitter address field, which is included in the PPDU header. The AP may acquire information corresponding to whether or not the PPDU corresponds to a PPDU (or frame) that is transmitted from an STA, which is associated with the AP, based on the transmitter address field being included in the PPDU header. In case the information included in the transmitter address field is different from the identification information of the STA being associated with the AP, the AP may not perform decoding of the MAC payload.

The BSSID indicator 1045 may indicate whether or not a BSSID field is included in the PPDU. The BSSID indicator 640 may include information on a BSSID of a BSS including the transmitting STA, which has transmitted the PPDU. The STA may acquire information on the BSS including the transmitting STA, which has transmitted the PPDU, based on the BSSID field being included in the PPDU header. Prior to the decoding of the MAC header, the AP may consider in advance whether or not the BSSID of the transmitting AP is identical to the BSSID of the STA and may then differently configure the respective CCA threshold values (or CCA sensitivity levels). The CCA sensitivity level may be used for determining whether the medium of the AP is idle/busy.

For example, in case the AP senses whether the medium is idle/busy based on a reception intensity of a PPDU being transmitted from another BSS, the AP may determine whether the medium is idle/busy based on a first CCA intensity level. Also, in case the AP senses whether the medium is idle/busy based on a reception intensity of a PPDU being transmitted from another BSS, the AP may determine whether the medium is idle/busy based on a second CCA intensity level. At this point, the first CCA intensity level may correspond to a value that is smaller than the second CCA intensity level.

The sequence control indicator 1055 may indicate whether or not a sequence control field is included in the PPDU header. In case the sequence control indicator 1055 is set to 1, the PPDU header may include the sequence control field. In case the PPDU carries a block ACK frame or a block ACK request frame, the AP may acquire in advance information on a sequence of data being included (or that are to be included) in the PPDU based on the decoding of a sequence control field being included in the PPDU header. Accordingly, the AP may perform processing in advance in a buffer prior to the decoding of the MAC header based on the sequence control field being included in the PPDU and may then gain time to access a memory.

The QoS control indicator 1065 may indicate whether or not a QoS control field is included in the PPDU header. In case the QoS control indicator 1065 is set to 1, the PPDU may include a QoS control field. The a QoS control field may include information on an ACK Policy. Therefore, the AP may acquire the ACK policy based on a QoS control field of the PPDU header and may then perform in advance operations in accordance with the ACK Policy prior to the decoding of the MAC header. For example, in case the ACK policy indicated based on the QoS control field of the PPDU header corresponds to No ACK, the AP is not required to prepare an ACK frame in advance. Depending upon whether the ACK policy indicated based on the QoS control field of the PPDU header corresponds to a delayed ACK or an immediate ACK, the AP may determine whether or not to disperse (or scatter) a load for generating an ACK frame in the MAC layer. In case the ACK policy corresponds to a delayed ACK, the processing of the AP for generating an ACK frame may be postponed (or delayed) to a relatively later order than the case when the ACK policy corresponds to the immediate ACK transmission.

The HT control indicator 1075 may indicate whether or not an HT control field is included in the PPDU header. In case the HT control indicator 1075 is set to 1, the PPDU header may include an HT control field. The HT control field may include information related to feedback. For example, in case the AP acquires in advance an HT control field based on the decoding of the PPDU header prior to the decoding of the MAC header, the AP may perform in advance processing that is related to rate adaptation.

For simplicity in the description, FIG. 10 disclosed an exemplary case when the MAC indicator field is included in the HE-SIG1 and when control information being indicated based on the MAC indicator field is included in the HE-SIG2. Each of the MAC indicator field and the control information being indicated based on the MAC indicator field may be included in the PPDU header in diverse formats. Additionally, as described above, an indicator being included in the MAC indicator field and control information being indicated based on the MAC indicator field and then included in the PPDU header may vary.

For example, each set of control information (or each MAC header field), which is indicated based on the MAC indicator field in accordance with the characteristics of a load situation (or status) of the AP, a processing performance of the AP, a request of the AP, a channel situation (or status), and a frame transmission/reception procedure, and which is then included in the UL MU PPDU, may be adaptively changed (or varied). In case the load of the AP is large, the AP may include a MAC header field for quickly determining whether or not to stop the decoding of the AP on the UL MU PPDU in order to allow the AP to quickly determine whether or not to stop the decoding. The control information (or a MAC header field) included in the UL MU PPDU may be determined based on information on the load of the AP, which is transmitted to the STA by the AP. Alternatively, the AP may request the STA to include and transmit a specific set of MAC header information in the UL MU PPDU.

As another example, in case the processing performance of the AP is decreased, the STA may include and transmit in advance a MAC header field for determining whether or not to end a decoding process in the UL MU PPDU.

As yet another example, the STA may selectively determine a required MAC header field in accordance with the transmit transmission/reception procedure and may then include and transmit the corresponding MAC header field in the UL MU PPDU. For example, the PPDU header of the UL MU PPDU being transmitted when the frame transmission and reception procedures are ended may not include separate duration/ID field, BSSID indicator field, QoS control indicator field, HT control indicator field, and so on.

In other words, the UL MU PPDU, which is disclosed in FIG. 10, may include a first field group (e.g., L-STF, L-LTF, L-SIG, HE-SIG1, HE-SIG2), which is encoded in channel units including sub-channels and then transmitted, and a second field group (e.g., HE-STF, HE-LTF, HE-SIG3, and MAC payload), which is encoded in sub-channel units and then transmitted. The first field group may include a first training field (e.g., L-STF, L-LTF), a first signal field (e.g., HE-SIG1), and a second signal field (e.g., HE-SIG2). Also, the second field group may include a second training field (e.g., HE-STF, HE-LTF), a third signal field (e.g., HE-SIG3), and a MAC payload, which are transmitted to the AP in a time-based order that is later than the second signal field.

The first signal field may include a MAC indicator field, the second signal field may include information on a sub-channel and at least one MAC header field, the third signal field may include information for the decoding of the MAC payload, the first training field may be used for channel estimation corresponding to the channel, and the second training field may be used for channel estimation corresponding to the sub-channel. The MAC payload may include a MAC header and a MAC body, which includes downlink data that are to be transmitted to the AP.

Such expression may also be applied to the DL MU PPDU format, which is disclosed in FIG. 6.

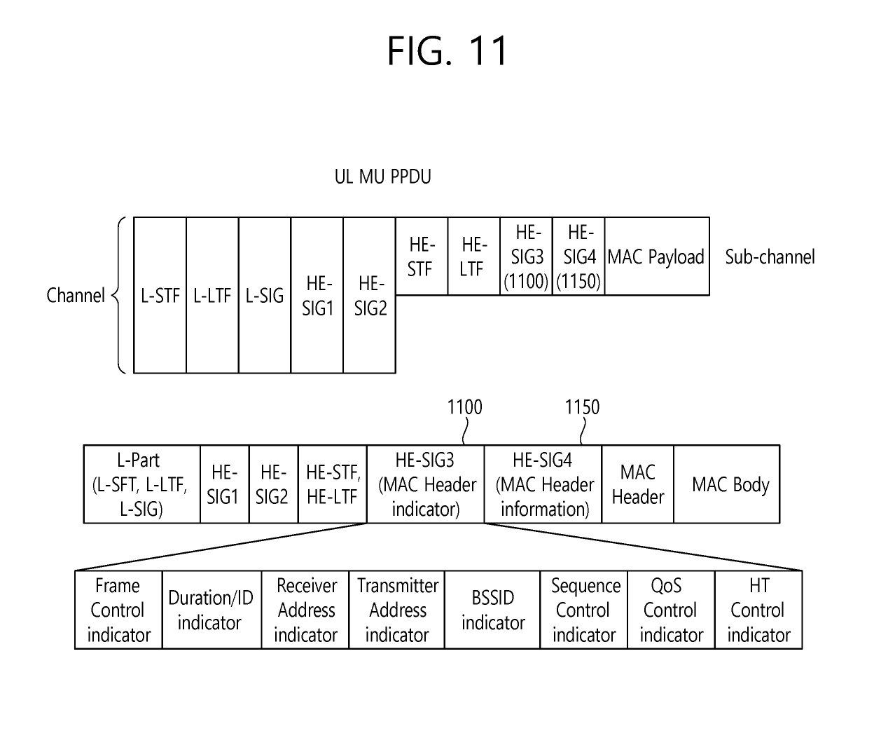

FIG. 11 is a conceptual view illustrating a UL MU PPDU format according to an exemplary embodiment of the present invention.

FIG. 11 discloses a UL MU PPDU format including a separate signal field, which includes control information being indicated based on the MAC indicator field.

Referring to FIG. 11, in the UL MU PPDU format, the MAC indicator field may be included in one signal field (e.g., HE-SIG3 1100) among the remaining signal fields excluding HE-SIG4 1150.

According to the exemplary embodiment of the present invention, the HE-SIG4 1150, which corresponds to a separate signal field including the control information being indicated based on the MAC indicator field, may be defined. The HE-SIG4 1150 may be positioned in a time-based position after the HE-SIG3 1100.

For example, the HE-SIG3 1100 may include a MAC indicator field, and the HE-SIG4 1150 may include a frame control field, a duration/ID field, a receiver address field, a transmitter address field, a BSSID field, a sequence control field, a QoS control field, and an HT control field.

In other words, the UL MU PPDU, which is disclosed in FIG. 11, may include a first field group (e.g., L-STF, L-LTF, L-SIG, HE-SIG1, HE-SIG2), which is encoded in channel units including sub-channels and then transmitted, and a second field group (e.g., HE-STF, HE-LTF, HE-SIG3, HE-SIG4, and MAC payload), which is encoded in sub-channel units and then transmitted.

The first field group may include a first training field (e.g., L-STF, L-LTF) and a first signal field (e.g., HE-SIG2), and the second field group may include a second training field (e.g., HE-STF, HE-LTF), a second signal field (e.g., HE-SIG3), a third signal field (e.g., HE-SIG4), and a MAC payload, which are transmitted to the AP in a time-based order that is later than the first signal field (HE-SIG2).

The first signal field may include information on the sub-channel, and the second signal field may include information for the decoding of the MAC payload and a MAC indicator field. The third signal field may include at least one MAC header field, the first training field may be used for channel estimation corresponding to the channel, the second training field may be used for channel estimation corresponding to the sub-channel, and the MAC payload may include a MAC header and a MAC body, which includes downlink data that are to be transmitted to the AP.

Such expression may also be applied to the UL MU PPDU format, which is disclosed in FIG. 7.

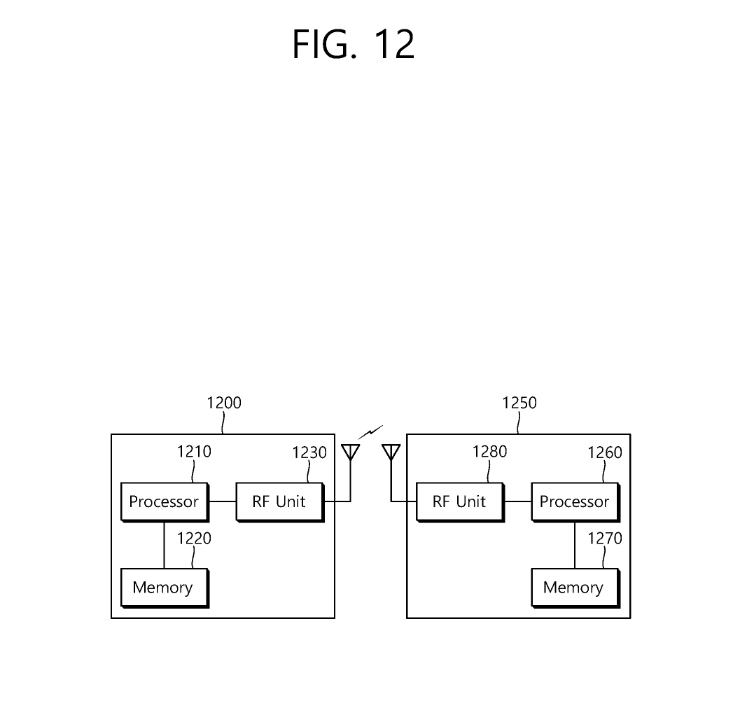

FIG. 12 is a block view illustrating a wireless device to which the exemplary embodiment of the present invention can be applied.

Referring to FIG. 12, the AP 1200 includes a processor 1210, a memory 1220, and a radio frequency (RF) unit 1230.

The RF unit 1230 is connected to the processor 1210, thereby being capable of transmitting and/or receiving radio signals.

The processor 1210 implements the functions, processes, and/or methods proposed in the present invention. For example, the processor 1210 may be implemented to perform the operations of the AP according to the above-described exemplary embodiments of the present invention. The processor may perform the operations of the AP, which are disclosed in the exemplary embodiments of FIG. 1 to FIG. 11.

For example, the processor 1210 may be configured to generate a PPDU header of a DL MU PPDU including a medium access control (MAC) indicator field and at least one MAC header field. The MAC indicator field may indicate at least one sub-indicator, and each of the at least one sub-indicator may indicate the presence or absence of each of the at least one MAC header field, and each of the at least one MAC header field may correspond to each of at least one field included in the MAC header of the DL MU PPDU.

Also, the processor 1210 may be configured to adaptively change (or vary) each set of control information (or each MAC header field), which is indicated based on the MAC indicator field in accordance with the characteristics of a load situation (or status) of the STA, a processing performance of the STA, a request of the STA, a channel situation (or status), and a frame transmission/reception procedure, and which is then included in the DL MU PPDU.

The STA 1250 includes a processor 1260, a memory 1270, and a radio frequency (RF) unit 1280.

The RF unit 1280 is connected to the processor 1260, thereby being capable of transmitting and/or receiving radio signals.

The processor 1260 implements the functions, processes, and/or methods proposed in the present invention. For example, the processor 1260 may be implemented to perform the operations of the STA according to the above-described exemplary embodiments of the present invention. The processor may perform the operations of the STA, which are disclosed in the exemplary embodiments of FIG. 1 to FIG. 11.

For example, the processor 1260 may be configured to receive a trigger frame from the AP and to transmit a UL MU PPDU to the AP through a sub-channel as a response to the received trigger frame. Also, the processor may be configured to generate a PPDU header of a UL MU PPDU including a medium access control (MAC) indicator field and at least one MAC header field. The MAC indicator field may indicate at least one sub-indicator, and each of the at least one sub-indicator may indicate the presence or absence of each of the at least one MAC header field, and each of the at least one MAC header field may correspond to each of at least one field included in the MAC header of the UL MU PPDU.

Moreover, the processor 1260 may be configured to adaptively change (or vary) each set of control information (or each MAC header field), which is indicated based on the MAC indicator field in accordance with the characteristic of a load situation (or status) of the AP, a processing performance of the AP, a request of the AP, a channel situation (or status), and a frame transmission/reception procedure, and which is then included in the UL MU PPDU.

The processor 1210 and 1260 may include an application-specific integrated circuit (ASIC), another chip set, a logical circuit, a data processing device, and/or a converter converting a baseband signal and a radio signal to and from one another. The memory 1220 and 1270 may include a read-only memory (ROM), a random access memory (RAM), a flash memory, a memory card, a storage medium, and/or another storage device. The RF unit 1230 and 1280 may include one or more antennas transmitting and/or receiving radio signals.

When the exemplary embodiment is implemented as software, the above-described method may be implemented as a module (process, function, and so on) performing the above-described functions. The module may be stored in the memory 1220 and 1270 and may be executed by the processor 1210 and 1260. The memory 1220 and 1270 may be located inside or outside of the processor 1210 and 1260 and may be connected to the processor 1210 and 1260 through a diversity of well-known means.

What is claimed is:

1. A method for transmitting data units in a wireless LAN system, comprising:
receiving, by a station (STA), a trigger frame from an access point (AP); and
transmitting, by the STA, an uplink multi user PHY protocol data unit (UL MU PPDU) to the AP within a sub-channel as a response to the trigger frame,
wherein the trigger frame includes UL MU identification information and UL MU resource allocation information,
wherein the UL MU identification information includes identification information of the STA and identification information of another STA transmitting another PPDU within a time resource overlapping with the STA,
wherein the UL MU resource allocation information includes information on the sub-channel and information on another sub-channel for transmitting the other UL MU PPDU,
wherein a PPDU header of the UL MU PPDU includes a medium access control (MAC) indicator field and at least one MAC header indicator,
wherein the MAC indicator field includes at least one sub-indicator,
wherein each of the at least one sub-indicator indicates a presence or absence of the at least one MAC header field, and
wherein each of the at least one MAC header field corresponds to each of at least one field being included in a MAC header of the UL MU PPDU.

2. The method of claim 1, wherein the UL MU PPDU includes a first field group being encoded and transmitted in channel units including the sub-channel, and a second field group being encoded and transmitted in sub-channel units,
wherein the first field group includes a first training field, a first signal field, and a second signal field,
wherein the second field group includes a second training field, a third signal field, and a medium access control (MAC) payload each being transmitted to the AP later than the second signal field in a time-based order,
wherein the first signal field includes the MAC indicator field,
wherein the second signal field includes information on the sub-channel and the at least one MAC header field,
wherein the third signal field includes information for decoding the MAC payload,
wherein the first training field is used for channel estimation corresponding to the channel,
wherein the second training field is used for channel estimation corresponding to the sub-channel, and
wherein the MAC payload includes the MAC header and a MAC body including downlink data that are to be transmitted to the AP.

3. The method of claim 1, wherein the UL MU PPDU includes a first field group being encoded and transmitted in channel units including the sub-channel, and a second field group being encoded and transmitted in sub-channel units,
wherein the first field group includes a first training field and a first signal field,
wherein the second field group includes a second training field, a second signal field, a third signal field, and a medium access control (MAC) payload each being transmitted to the AP later than the first signal field in a time-based order,
wherein the first signal field includes information on the sub-channel,
wherein the second signal field includes information for decoding the MAC payload and the MAC indicator field,
wherein the third signal field includes the at least one MAC header field,
wherein the first training field is used for channel estimation corresponding to the channel,
wherein the second training field is used for channel estimation corresponding to the sub-channel, and
wherein the MAC payload includes the MAC header and a MAC body including downlink data that are to be transmitted to the AP.

4. The method of claim 1, wherein the at least one sub-indicator includes a duration/ID indicator, a receiver address indicator, and a transmitter address indicator,
wherein the duration/ID indicator indicates whether or not a duration/ID field that is identical to a duration/ID field being included in the MAC header is included in the PPDU header,
wherein the receiver address indicator indicates whether or not a receiver address field being included in the MAC header is included in the PPDU header, and
wherein the transmitter address indicator indicates whether or not a transmitter address field being included in the MAC header is included in the PPDU header.

5. The method of claim 1, wherein the at least one MAC header field is adaptively determined in accordance with a load situation of the AP.

6. A station (STA) transmitting data units in a wireless LAN, comprising:
a radio frequency (RF) unit transmitting and receiving radio signals; and
a processor being operatively connected to the RF unit,
wherein the processor is configured:
to receive a trigger frame from an access point (AP), and
to transmit an uplink multi user PHY protocol data unit (UL MU PPDU) to the AP within a sub-channel as a response to the trigger frame,
wherein the trigger frame includes UL MU identification information and UL MU resource allocation information,
wherein the UL MU identification information includes identification information of the STA and identification information of another STA transmitting another PPDU within a time resource overlapping with the STA,
wherein the UL MU resource allocation information includes information on the sub-channel and information on another sub-channel for transmitting the other UL MU PPDU,
wherein a PPDU header of the UL MU PPDU includes a medium access control (MAC) indicator field and at least one MAC header indicator,
wherein the MAC indicator field includes at least one sub-indicator,
wherein each of the at least one sub-indicator indicates a presence or absence of the at least one MAC header field, and
wherein each of the at least one MAC header field corresponds to each of at least one field being included in a MAC header of the UL MU PPDU.

7. The STA of claim 6, wherein the UL MU PPDU includes a first field group being encoded and transmitted in channel units including the sub-channel, and a second field group being encoded and transmitted in sub-channel units,
wherein the first field group includes a first training field, a first signal field, and a second signal field,
wherein the second field group includes a second training field, a third signal field, and a medium access control (MAC) payload each being transmitted to the AP later than the second signal field in a time-based order,
wherein the first signal field includes the MAC indicator field,
wherein the second signal field includes information on the sub-channel and the at least one MAC header field,
wherein the third signal field includes information for decoding the MAC payload,
wherein the first training field is used for channel estimation corresponding to the channel,
wherein the second training field is used for channel estimation corresponding to the sub-channel, and
wherein the MAC payload includes the MAC header and a MAC body including downlink data that are to be transmitted to the AP.

8. The STA of claim 6, wherein the UL MU PPDU includes a first field group being encoded and transmitted in channel units including the sub-channel, and a second field group being encoded and transmitted in sub-channel units,
wherein the first field group includes a first training field and a first signal field,
wherein the second field group includes a second training field, a second signal field, a third signal field, and a medium access control (MAC) payload each being transmitted to the AP later than the first signal field in a time-based order,
wherein the first signal field includes information on the sub-channel,
wherein the second signal field includes information for decoding the MAC payload and the MAC indicator field,
wherein the third signal field includes the at least one MAC header field,
wherein the first training field is used for channel estimation corresponding to the channel,
wherein the second training field is used for channel estimation corresponding to the sub-channel, and
wherein the MAC payload includes the MAC header and a MAC body including downlink data that are to be transmitted to the AP.

9. The STA of claim 6, wherein the at least one sub-indicator includes a duration/ID indicator, a receiver address indicator, and a transmitter address indicator,
wherein the duration/ID indicator indicates whether or not a duration/ID field that is identical to a duration/ID field being included in the MAC header is included in the PPDU header,
wherein the receiver address indicator indicates whether or not a receiver address field being included in the MAC header is included in the PPDU header, and
wherein the transmitter address indicator indicates whether or not a transmitter address field being included in the MAC header is included in the PPDU header.

10. The STA of claim 6, wherein the at least one MAC header field is adaptively determined in accordance with a load situation of the AP.
